(19) United States
(12) Patent Application Publication
(10) Pub. No.: US 2018/0018672 A1
(43) Pub. Date: Jan. 18, 2018

(54) METHOD AND SYSTEM TO PREVENT FRAUD IN PAYMENT SYTEMS TRANSITIONING TO MOBILE PAYMENT AND CHIP CARDS

(71) Applicant: Jack Shauh, San Diego, CA (US)

(72) Inventor: Jack Shauh, San Diego, CA (US)

(21) Appl. No.: 15/642,291

(22) Filed: Jul. 5, 2017

Related U.S. Application Data
(60) Provisional application No. 62/363,386, filed on Jul. 18, 2016.

(51) Int. Cl. G06Q 20/40; G06Q 20/34; G06Q 20/32

(52) U.S. Cl. CPC G06Q 20/4016; G06Q 20/322; G06Q 20/34

(57) ABSTRACT

A payment system for reducing fraud is payment card transactions. The system includes a payment device coupled through a merchant to a payment network and a fraud prevention system coupling an issuing bank to the payment network. The fraud prevention system includes a transaction processing module and a monitor/detect module. The transaction processing module receives transaction messages from the payment network and sends transaction messages to the payment network from the issuing bank and provides transaction processing to approve or reject transactions. The monitor/detect module is coupled between the transaction module and a database module storing payment method data. The monitor/detect module compares established payment precedent of parties to a transaction to detect fraud and sends feedback to the transaction processing module.

### CROSS-REFERENCE TO RELATED APPLICATION

This application claims the benefit of U.S. Provisional Application No. 62/363,386, filed 18 Jul. 2016.

### FIELD OF THE INVENTION

This invention relates to smart card and mobile payment systems.

More particularly, the present invention relates to reducing fraud in transitioning to mobile payment and smart card systems use.

### BACKGROUND OF THE INVENTION

In the past, credit card use as a payment method included using the credit card number (i.e. primary account number (PAN)) either entered manually by the merchant or purchaser, or entered by swiping the magnetic stripe of the credit card for authentication. This old payment method led to high levels of fraud. Credit card numbers, counterfeit magstripes and other information could be obtained by fraudulent users and used for purchases. The credit or debit payment industry has started to migrate from magnetic stripe cards to smart chip cards using the EMV (Europay, Master and Visa) protocols. When using an EMV card, the authentication of the card can be verified by using a cryptogram generated by the smart chip in the card. Meanwhile, mobile payment systems using mobile devices as a platform are emerging. Mobile payment applications as a virtual credit/debit card are starting to be provided to mobile devices such as smart phones, tablets, watches and other wearable devices, and the like. Mobile payment systems currently include a few different payment schemes, such as Apple Pay, Android Pay, Samsung Pay, Walmart Pay, Etc. These new payment methods can provide better security by authenticating the card, or the device and even hiding the credit or debit card number, i.e. primary account number (PAN) using encryption or payment token.

While these new payment methods are starting to be adopted by customers and merchants, it will take time before they become pervasive. During the transition period between switching from using the old payment method, using credit and debit card numbers, and the new payments methods, using mobile payment and EMV cards, it will be necessary for customers and merchants to be able to use the old payment methods with the credit or debit card number and the new methods which are more secure. This is especially true for the online merchants that traditionally only take credit or debit card number, i.e. PAN, for processing the transaction. Therefore, fraudulent transactions generally avoidable by using the new payments will still easily occur due to the possible use of the old methods. This invention provides new solutions for preventing fraudulent transactions in this transition period from the old payment methods to the new payment methods.

It would be highly advantageous, therefore, to remedy the foregoing and other deficiencies inherent in the prior art.

An object of the present invention is to provide a method and system for reducing the occurrences of fraud in payment systems.

### SUMMARY OF THE INVENTION

Briefly, to achieve the desired objects and advantages of the instant invention, provided is a payment system. The payment system includes a payment device coupled through a merchant to a payment network and a fraud prevention system coupling an issuing bank to the payment network. The fraud prevention system includes a transaction processing module and a monitor/detect module. The transaction processing module receives transaction messages from the payment network and sends transaction messages to the payment network from the issuing bank and provides transaction processing to approve or reject transactions. The monitor/detect module is coupled between the transaction module and a database module storing payment method data. The monitor/detect module compares established payment precedent of parties to a transaction to detect fraud and sends feedback to the transaction processing module.

Also provided is a card payment method with fraud detection. This method includes providing a payment device coupled through a merchant to a payment network. A fraud prevention system is provided, coupling an issuing bank to the payment network. The fraud prevention system includes a database storing payment methods accepted by the merchant. A payment card is provided which is capable of both old payment methods and new payment methods. A payment transaction is made with the payment card using the payment device and a payment method. The payment method is one of an old payment method and a new payment method. An authorization request message is sent from the payment device to the payment network, the authorization request message including information on the payment method. The authorization request message is forwarded from the payment network to the fraud prevention system of the issuing bank. The payment method used in the payment transaction is compared to the payment methods accepted by the merchant. An authorization response is sent to the payment network. The authorization response being an approval or a rejection. An approval is sent when the payment method used in the payment transaction is a new payment method. An approval is also sent if the payment method used in the payment transaction is an old payment method and the merchant does not accept a new payment method supported by the payment card. A rejection is sent if the payment method is an old payment message and the merchant accepts a new payment method supported by the payment card.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a schematic of the message exchange between elements of a payment system and a user;

FIG. 2 is a schematic of the message exchange between elements of the payment system according to the present invention;

FIG. 3 is a schematic of the message exchange between elements of the payment system with an alert function; and

FIG. 4 is simplified block diagram of a fraud prevention system provided to an issuing bank.

### DETAILED DESCRIPTION OF THE PREFERRED EMBODIMENTS

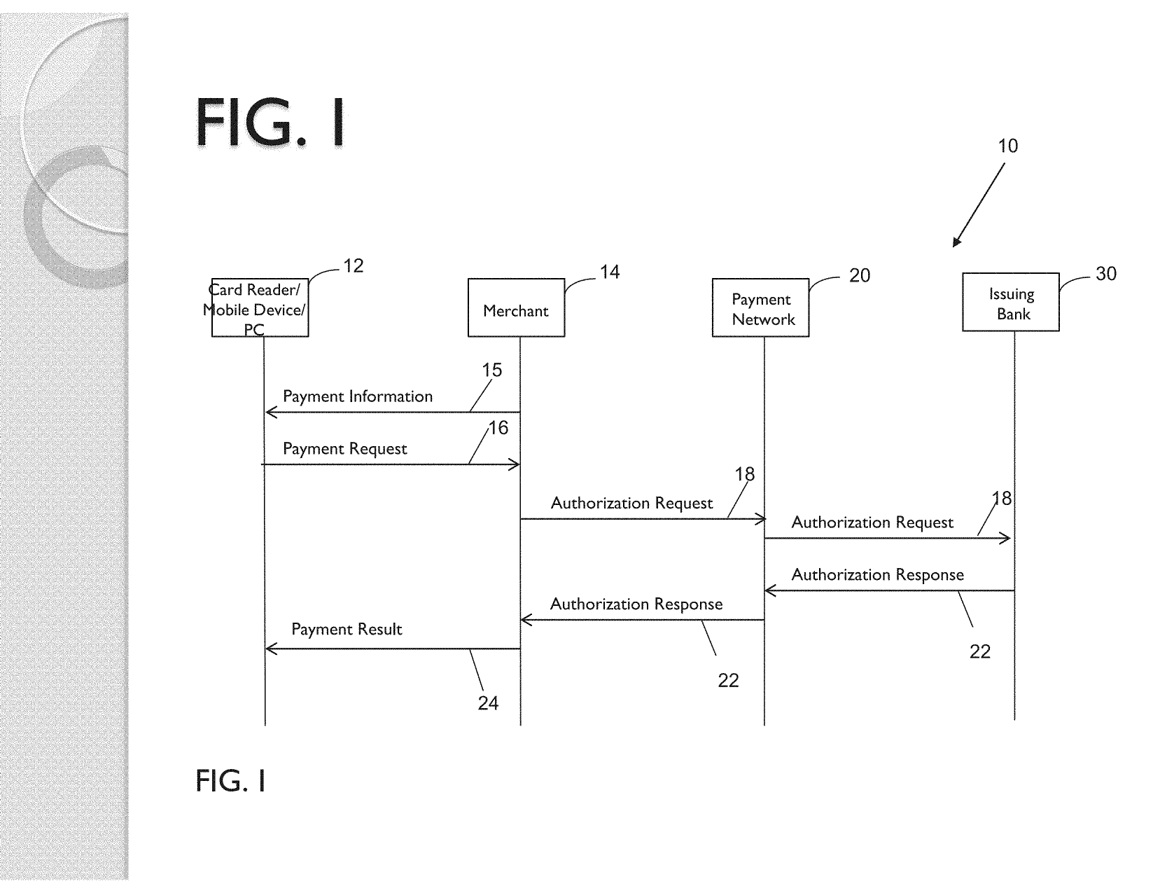

Turning now to the drawings in which like reference characters indicate corresponding elements throughout the several views, attention is first directed to FIG. 1 which illustrates an example of a conventional payment card payment transaction flow of a payment system 10. It will be understood that payment card as used in this specification is defined as a credit/debit card, and includes virtual credit/debit cards as used in mobile payment systems. A customer uses a credit or debit card (magnetic stripe or EMV based) on a payment device 12, such as a card reader, mobile device or PC to pay for a purchase with a merchant 14. Merchant 14 can be a brick-and-mortar store or an online store. Merchant 14 sends a payment information message 15 to payment device 12. Payment information message 15 includes payment information such as payment amount, currency code, and the like. Payment device 12 sends a payment request message 16 to merchant 14. This is accomplished in a variety of methods, broken into two groups, old payment methods and new payment methods. An old payment method requires a swipe of the magstripe or for the customer or merchant to manually input a credit card or debit card number via payment device 12 such as when a PC is employed and the information is manually input into a webpage. A new payment method is when payment device 12 is a card reader which can interface with an EMV Card to exchange data. Another new payment method is when the payment device is a mobile device using a mobile application to submit payment requests to the merchant via a mobile device or another PC device. Payment request message 16 can include the credit/debit card number, expiration date, transaction amount, etc. If an EMV card or mobile payment is used, security procedures are generally used, such as including an application cryptogram to authenticate the card, mobile device and message, and ciphering data in the message. If this is token based method, e.g. Apple Pay, Android Pay, Samsung Pay, and the like, then the mobile payment will only provide an encrypted token (token is a substitute PAN) and token cryptogram. When merchant 14 receives payment request message 16, merchant 14 generates an authorization request message 18. Authorization request message 18 is sent to a payment network 20 (e.g., consisting of payment gateway, acquiring bank, brand network, token service provider, etc.). Payment network 20 forwards authorization request message 18 to an issuing bank 30 which must approve or reject the transaction. On approving the transaction, issuing bank 30 replies to payment network 20 with an authorization response message 22. Payment network 20 forwards authorization response message 22 to merchant 14. Merchant 14 replies with a payment result 24 to payment device 12. This process illustrates both old payment methods and new payment methods currently used in credit card and debit card transactions. While some transactions may be secure (new payment method), others may not be (old payment method), but each can potentially be employed.

In the method and system of the present invention, card issuing bank 30 can reduce fraud by keeping records of the customer's payment habits, specifically whether the customers payment card is an EMV card and whether the customer uses mobile payment. Issuing bank 30 also maintains records on what type of payment method a merchant accepts and whether the customer can use that payment method. If the customer uses an EMV credit or debit card or mobile payment method X (new payment method) at a particular merchant which will accept EMV card or mobile payment method X, then the authorization is accepted. However, if the actual transaction is submitted by using the credit or debit card number (old payment method) to pay rather than using EMV card or mobile payment method X when available to both parties, the transaction is rejected. Thus, if using a new payment method is possible, and issuing bank 30 does a comparison and knows it is possible, an old payment method using a credit card number submitted to the POS terminal of the brick-and-mortar store or the web of the online store of the merchant is suspect. Therefore, card issuing bank 30 can detect such an irregularity and reject the transaction. If the customer's new payment method is not accepted by the merchant, issuing bank will approve an old payment method since that method is the only possible method.

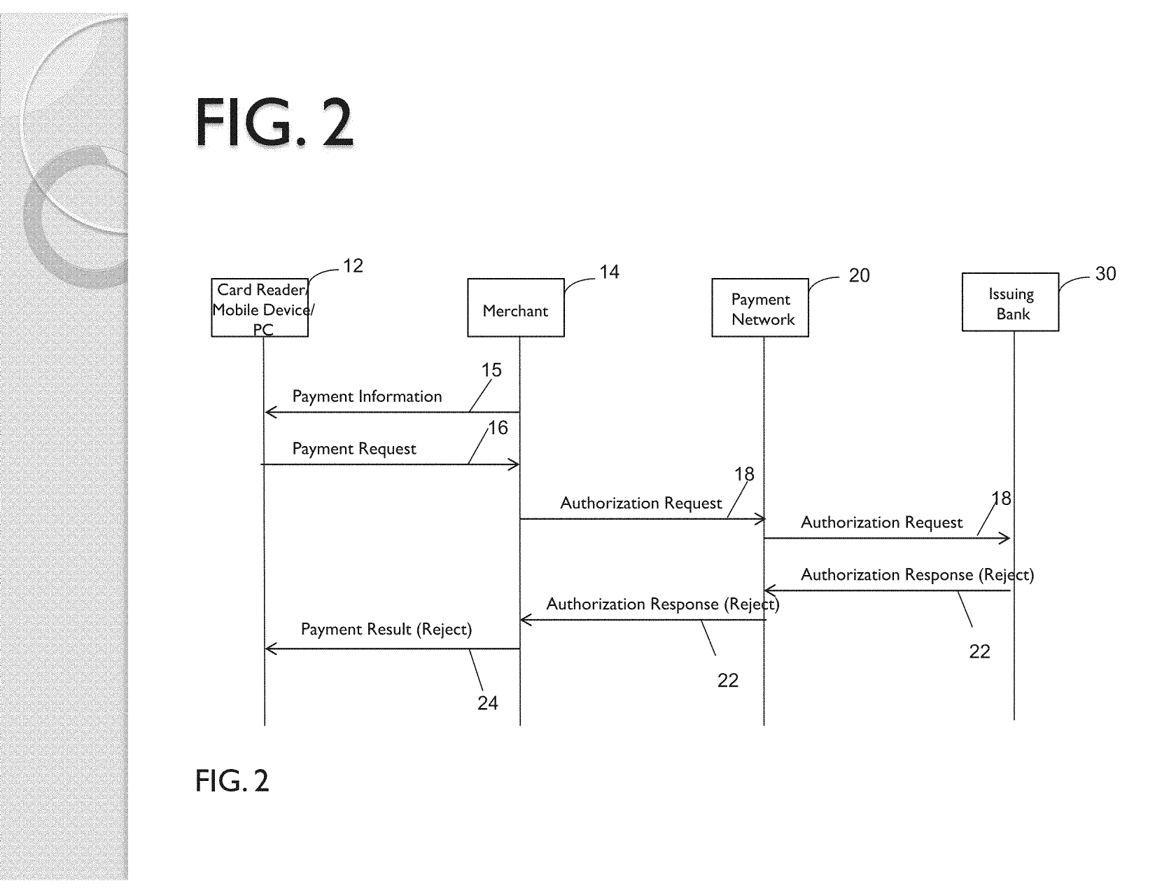

Referring to FIG. 2, a message flow according to the method and system of the present invention is illustrated. A customer intends to use a payment card to pay for the purchase with merchant 14, which can be a brick-and-mortar store or an online store. Merchant 14 sends payment information message 15 with payment amount, currency code, etc. to payment device 12. At this point several payment methods can be employed, depending on payment device 12 which include old payment methods such as: entering the card number on payment device 12 (PC or mobile device); reading the magnetic stripe card on payment device 12 (card reader of POS terminal); or new payment methods such as: reading IC card on payment device 12 (the card reader of POS terminal or mobile device); paying with a mobile device using payment device 12 (mobile payment via POS terminal); and purchasing on PC and paying and/or authorizing with payment device 12 (mobile device using mobile payment). Payment device 12 sends payment request message 16 to merchant 14 to pay. Payment request message 16 can include the credit/debit card number, expiration date. When merchant 14 receives payment request message 16, merchant 14 generates an authorization request message 18. Authorization request message 18 is sent to a payment network 20 (e.g., consisting of payment gateway, acquiring bank, brand network, token service provider, etc.). Payment network 20 forwards authorization request message 18 to an issuing bank 30 which must approve or reject the transaction. In addition, payment network 20 passes data elements related to a payment method used, such as specific mobile payment method X, and a primary account number (i.e. PAN) received from merchant 14. Issuing bank 30 knows that the credit/debit account has EMV card or mobile payment and merchant 14 is capable of accepting EMV card and/or the mobile payment method X that the customer can use. Issuing bank 30 detects that the transaction is submitted by the merchant 14 only with the credit/debit card number, namely PAN (Primary Account Number). Issuing bank 14 rejects the transaction and replies to payment network 20 with authorization response message 22. In this case, authorization response message 22 is a rejection of the transaction. Issuing bank 30 knows that the account has EMV card by previous card activation process or mobile payment by previous registration process. Payment network 20 forwards authorization response message 22 rejecting the transaction to merchant 14. Merchant 14 sends payment result 24 to payment device 12, rejecting the transaction. Authorization request message 18 and authorization response message 22 are based on the ISO 8583 messages, e.g. Authorization Request and Authorization Response. Issuing bank 30 knows the capability of merchant 14 to accept EMV card or mobile payment by received authorization request message 18 (e.g. Message type indicator=0100 in decimal digits). Furthermore, issuing bank 30 can learn from the payment methods of the previous transactions of this merchant, e.g. previous authorization request messages 18.

Alternatively, the issuing bank may send an alert to the customer while the transaction is approved (or rejected). To turn on the alert messaging, the customer logs into issuing bank's website to enable this option.

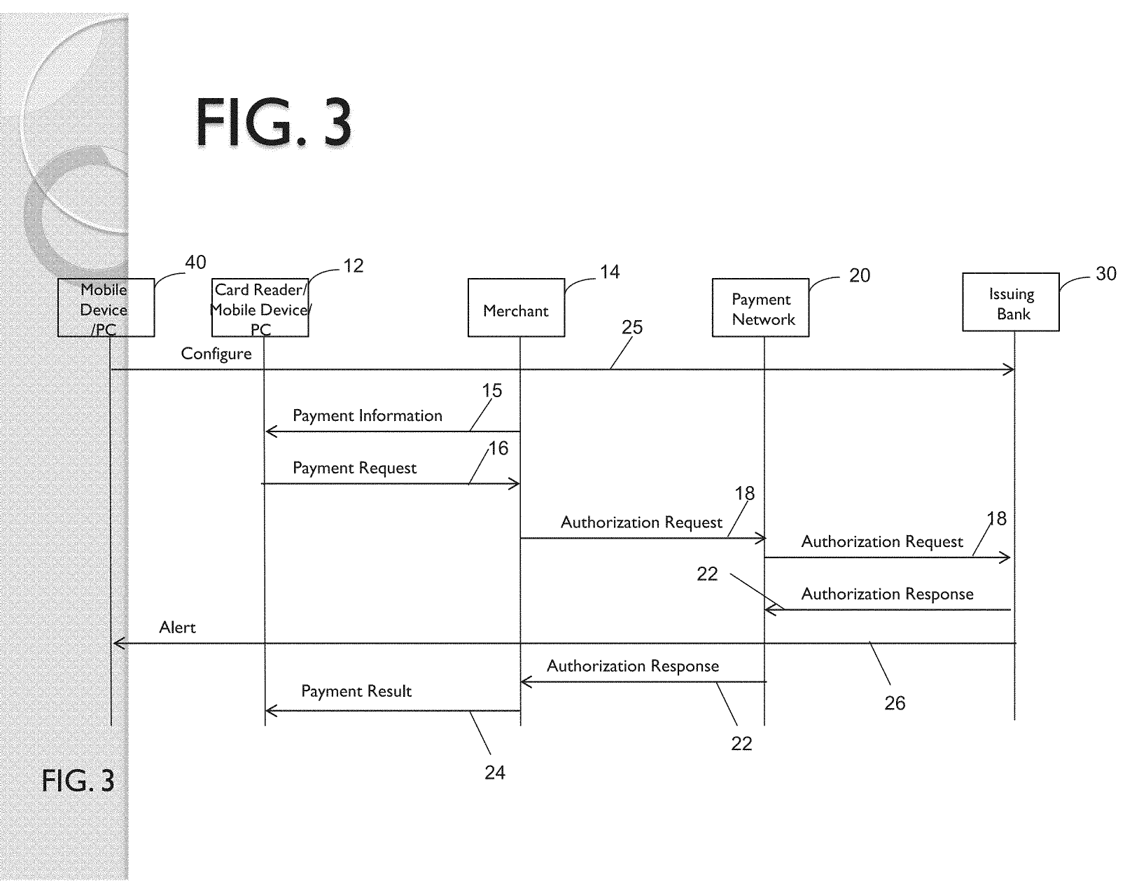

Turning now to FIG. 3, another message flow according to the method and system of the present invention is illustrated. The customer uses a web browsing capable device 40 such as a mobile device or PC to log in to a website to configure 25 a transaction with issuing bank 30. The configuration of the transaction with issuing bank 30 includes selecting an alert option when the credit or debit card number (i.e. PAN) is used for payment instead of using EMV card or mobile payment. Merchant 14 sends payment information message 15 with payment amount, currency code, etc. to payment device 12. At this point several payment methods can be employed, depending on payment device 12 which include old payment methods such as: entering the card number on payment device 12 (PC or mobile device); reading the magnetic stripe card on payment device 12 (card reader of POS terminal); or new payment methods, such as: reading IC card on payment device 12 (the card reader of POS terminal or mobile device); paying with a mobile device using payment device 12 (mobile payment via POS terminal); and purchasing on PC and paying and/or authorizing with payment device 12 (mobile device using mobile payment). Payment device 12 sends payment request message 16 to merchant 14 to pay. Payment request message 16 can include the credit/debit card number, expiration date. When merchant 14 receives payment request message 16, merchant 14 generates an authorization request message 18. Authorization request message 18 is sent to a payment network 20 (e.g., consisting of payment gateway, acquiring bank, brand network, token service provider, etc.). Payment network 20 forwards authorization request message 18 to an issuing bank 30 which must approve or reject the transaction. In addition, payment network 20 passes data elements identifying the payment method used, such as a specific mobile payment method X, and a primary account number (i.e. PAN) received from the Merchant. Issuing bank 30 detects that the customer has enabled the alert service for notification if only a credit/debit card number to pay instead of EMV Card or mobile payment. Issuing bank 30 also knows that merchant 14 is capable of accepting EMV card and mobile payment brand method X that the customer can use. Issuing bank 30 can approve or reject the transaction and replies to payment network 20 with authorization response message 22. Issuing bank 30 also sends an alert message 26 to web browsing capable device 40, e.g. SMS/MMS, email, push notification, or phone call with alert message. Payment network 20 returns with authorization response message 22 to merchant 14. Merchant 14 then sends payment result 24 to payment device 12.

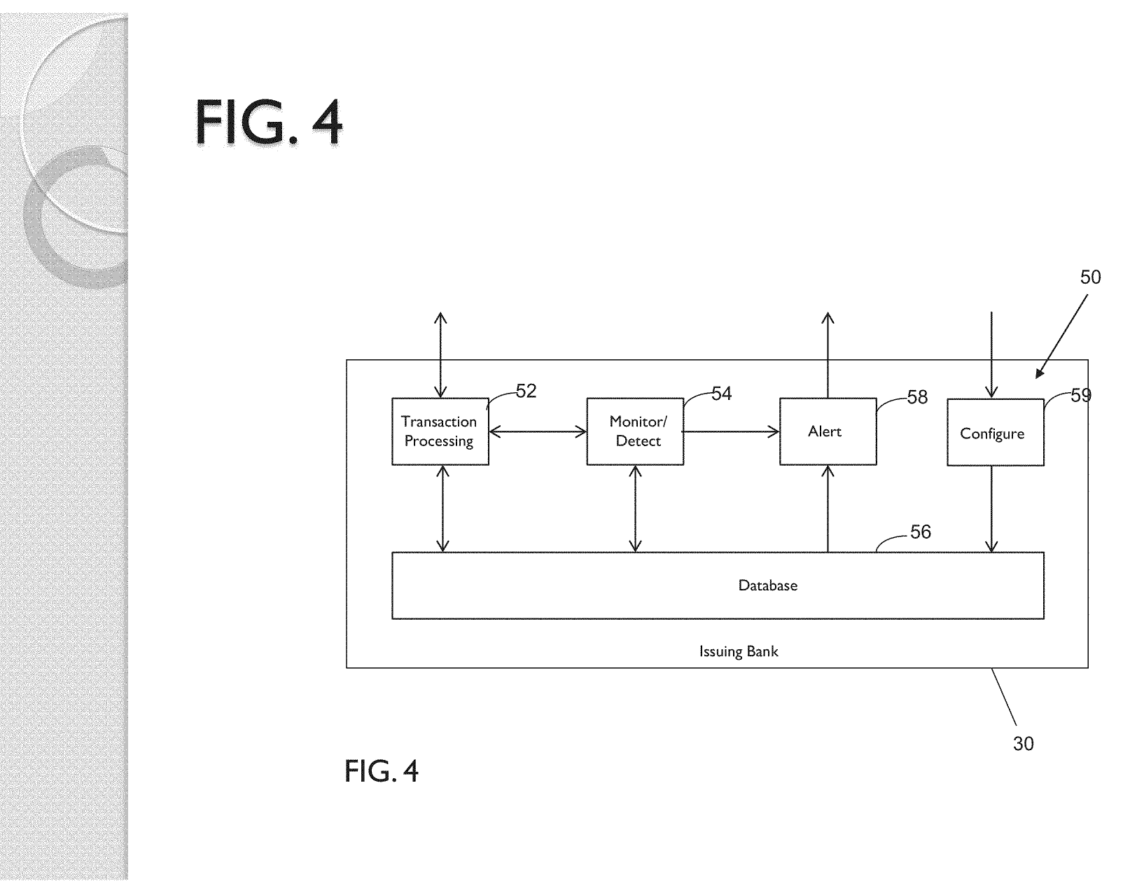

Turning now to FIG. 4, a fraud prevention system, generally designated 50 is provided at issuing bank 30 to limit the unsecured transactions. A transaction processing module 52 provides the credit/debit card transaction processing to approve or reject credit/debit card transactions and receive or reply with transaction messages described previously. A monitor/detect module 54 provides fraud monitoring and detecting functions as described previously. For example, monitor/detect module 54 can receive the method of payment (e.g. old method with credit/debit number or new method with tokenization and the like), use the merchant payment capability (support EMV card or mobile payment) and customer account payment capability (EMV card or mobile payment) in a comparison with established payment precedent to detect fraud. Monitor/Detect module 54 receives the method of payment from transaction processing module 52 and receives the payment capability of merchant 14 and customer account from a database module 56. Once fraud is detected, monitor/detect module 54 provides feedback to transaction processing module 52 to reject the transaction. Monitor/Detect module 54 also stores transaction monitor or detect history information per credit/debit card account in database 56. An alert module 58 sends alert message 26 to the customer, e.g. SMS, MMS, email, or phone call. Alert module 58 is enabled by a configure module 59 as to whether or not alert service is desired. Configure module 59 allows the credit/debit card holder to select to receive alert message 26, enabling alert module 58 when the credit/debit card number is used for a payment transaction instead of EMV Card, or mobile payment method X when the merchant is capable of accepting EMV card and mobile payment method X. Database module 56 not only stores each card holder's account information, credit balance, credit/debit card payment capability but also stores each merchant's payment acceptance capability which may be learned from payment network 20 or an acquiring bank. In addition, database module 56 stores the status of enabling or disabling alert service for that credit/debit card account.

Thus, by using fraud prevention system 50 in payment system 10, an issuing bank 30 can employ stored and received data regarding the payment method available to the customer and payment method available to merchant 14 to determine suspect transactions. A customer that typically uses an EMV card or mobile payment, that uncharacteristically uses an old method payment at a merchant capable of accepting the EMV card or mobile payment, is a suspect transaction and triggers an alert. Only if the merchant does not accept the EMV card or the mobile payment method will old method payments not be suspect.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A payment system comprising:
a payment device coupled through a merchant to a payment network;
a fraud prevention system coupling an issuing bank to the payment network, the fraud prevention system comprising:
a transaction processing module receiving transaction messages from the payment network and sending messages to the payment network from the issuing bank and providing transaction processing to approve or reject transactions; and
a monitor/detect module coupled between the transaction module and a database module storing payment method data for comparing established payment precedent of parties to a transaction to detect fraud and sending feedback to the transaction processing module.

2. A payment system as claimed in claim 1 wherein the fraud prevention system further comprises:
an alert module coupled to the database module and the monitor/detect module and couplable to a web browsing capable device for sending an alert message thereto; and
a configure module coupled to the database module accessible by a cardholder to enable the alert module to send the alert message when the feedback is a transaction rejection.

3. A payment system as claimed in claim 1 wherein the payment device is one of a card reader, a mobile device and a PC.

4. A card payment method with fraud detection comprising the steps of:
providing a payment device coupled through a merchant to a payment network;
providing a fraud prevention system coupling an issuing bank to the payment network, the fraud prevention system including a database storing payment methods accepted by the merchant;
providing a payment card capable of both old payment methods and new payment methods;
making a payment transaction with the payment card using the payment device and a payment method, the payment method being one of an old payment method and a new payment method;
sending an authorization request message from the payment device to the payment network, the authorization request message including information on the payment method;
forwarding the authorization request message from the payment network to the fraud prevention system of the issuing bank;
comparing the payment method used in the payment transaction to the payment methods accepted by the merchant; and
sending an authorization response to the payment network, the authorization response being one of an approval and a rejection, an approval when the payment method used in the payment transaction is a new payment method, an approval when the payment method used in the payment transaction is an old payment method and the merchant does not accept a new payment method supported by the payment card, and a rejection if the payment method is an old payment message and the merchant accepts a new payment method supported by the payment card.

5. A card payment method with fraud detection as claimed in claim 4 wherein the step of providing a fraud prevention system includes:
providing a transaction processing module receiving transaction messages from the payment network and sending messages to the payment network from the issuing bank and providing transaction processing to approve or reject transactions; and
providing a monitor/detect module coupled between the transaction module and the database module storing payment method data for comparing established payment precedent of parties to a transaction to detect fraud and sending feedback to the transaction processing module.

6. A card payment method with fraud detection as claimed in claim 5 wherein the step of providing a fraud prevention system further includes:
providing an alert module coupled to the database module and the monitor/detect module and couplable to a web browsing capable device; and
providing a configure module coupled to the database module accessible by a cardholder to enable the alert module to send the alert message when the feedback is a transaction rejection.
